(19) United States
(12) Patent Application Publication
(10) Pub. No.: US 2005/0076380 A1
(43) Pub. Date: Apr. 7, 2005

(54) System and method for testing the compliance of a digital decoding device

(76) Inventors: Andre Magras, Saint Gregoire (FR); Stephane Allie, Saint Armel (FR); Laurent Oreal, Cesson Sevigne (FR)

Correspondence Address: Joseph S Tripoli;Thomson Licensing Inc, Patent Operations CN 5312, Princeton, NJ, 08543-0028, US

(21) Appl. No.: 10/491,486

(22) PCT Filed: Oct. 2, 2002
(86) PCT No.: PCT/EP02/11051

(30) Foreign Application Priority Data
Oct. 2, 2001 (FR) 0112651

(51) Int. Cl. H04N 7/173

(52) U.S. Cl. 725/107

(57) ABSTRACT

The system comprises a separate unit for calculating quality parameters relating to results obtained from video test sequences by means of the device to be tested and nonlinear as a function of these results. It also comprises a unit for comparing, over time, these parameters and corresponding quality parameters, the latter being associated with reference results relating to video test sequences. The comparison unit produces binary results corresponding respectively to the quality parameters by means of predetermined tolerance margins, thereby allocating to each of the binary results corresponding to one of the quality parameters a first value when the quality parameter associated with the device to be tested remains within the tolerance margin around the quality parameter associated with the reference results, over time, and otherwise, a second value. Application to an IRD.

The present invention relates to compliance tests for digital devices for decoding encoded video signals.

Digital television broadcasts must comply with standards, such as the MPEG-2 (for “Moving Picture Experts Group”) standard and the DVB (for “Digital Video Broadcasting”) standard. The latter must be complied with during the various steps required between the initial encoding of a video sequence and the display on the screen of this video sequence reconstructed in receivers provided with decoders, called IRDs (for “Integrated Receivers Decoders”). The IRDs especially include television sets fitted with integrated decoders, and separate receiving and decoding boxes (called “set-top boxes”). In particular, it is worth ensuring that the digital decoding devices used are capable of meeting the requirements relating to the standards above.

In order to do this, the compliance of the decoding devices must be tested according to pre-established criteria making it possible to establish that these devices are either satisfactory or unsatisfactory. Careful selection of the criteria makes it possible not only to verify that the standards in force are complied with, but also makes it possible to take account of greater requirements, capable of enhancing the visual comfort of the user and the reliability of images reconstructed on the screen.

IRD compliance tests have thus been developed. Generally, they consist in applying encoded test video samples both to an MPEG-2 video decoding chip to be tested and to a reference decoder. In this way, test and reference decoding files, respectively, of the 4:2:0 type are generated and a point-by-point and image-by-image subtraction of the two files is carried out. The difference file obtained gives the difference between the results desired (reference decoder) and those actually produced (decoder to be tested). By carefully selecting the video samples and the maximum permissible difference, the compliance or the noncompliance of the decoder to be tested is established.

However, this method is very costly in terms of computing and time, and requires concentrating on a small number of images. Furthermore, the overall pixel-by-pixel difference does not allow digital video degradation, such as jumps between macro blocks or poor transitions, to be efficiently qualified.

U.S. Pat. No. 6,137,904 proposes a method making it possible to assess the visibility of differences between two input signal sequences. It consists in carrying out a pixel-by-pixel difference between signals to be tested and reference signals, using quantities such as luminance and chrominance components, then in generating measurements of these differences associated with user perceptions, in the form of JNDs (for “Just-Noticeable Differences”). In particular, the method is applicable to a decoder (col. 4, I. 13). It offers very interesting possibilities of evaluating the subjective quality of sequences obtained with the decoder to be tested, and could eventually be envisaged for verifying the compliance thereof.

Such an application would have the advantage of implementing criteria better suited to the particular features of visual perception than a single uniform standard relating to difference files. However, it would also require considerable computing and storage resources, thus penalizing the possibilities of tests—limiting the number of images, time elapsed, etc.

Other documents disclose techniques making it possible to produce picture quality ratings by comparing parameters extracted respectively from a stream to be tested and a reference stream. Thus, document EP-A-0 986 269 relates to the analysis of picture quality in real time, according to which the impairment of a video test signal is determined with respect to a reference signal. To do this, corresponding parameters of two signals, for example spatial or temporal energy, are generated and they are compared over time so as to supply a picture quality rating representative of the impairment of the video test signal.

Moreover, U.S. Pat. No. 6,285,797 describes a method of estimating digital video quality without a reference (“single ended process”), which is based on generating a virtual reference from the video stream to be tested. More specifically, energy maps are produced both for an imaginary signal extracted from the signal to be tested and for a combination of this signal and an estimated distortion. The comparison of the two maps gives a quality rating.

These last techniques are suitable for the production of quality ratings, giving various information concerning the capacities of the device that it is desired to test. However, they are not designed for compliance tests, which would make it possible to establish the validity of this device. Specifically, changing the results obtained, based on quality ratings, in to a verdict of compliance, appears a priori to require steps which may prove to be complex and costly in terms of computing, and even seems impossible in some cases, insofar as the quality ratings are not necessarily significant for a compliance test.

The present invention relates to a system for testing the compliance of a digital device for decoding encoded video signals, making it possible to obtain information which is relevant with respect to the subjective perception of users, which is less costly in terms of computing and storage, it being possible for these costs to be substantially less than those required by the known methods in this field.

The system of the invention not only makes it possible to generate a reliable binary result for a compliance test, but may also provide a clear-cut diagnosis with regard to possible faults or weaknesses of the decoder.

The subject of the invention is also a method for testing the compliance of a digital decoding device, having the same advantages as the system of the invention.

In particular, it is applicable to production lines for decoders, so as to guarantee product compliance. The system of the invention may thus be implemented in the form of specialized test rigs, which can be used in the factory. It may also be implemented directly within decoding units, on a reduced distribution scale (decoders dedicated to tests) or on a large scale (integration into mass-produced products), by virtue of its relatively low requirements in terms of computing and storage capacities. The invention thus offers possibilities of localized inspection at the decoders themselves, which may prove to be particularly useful for the after-sales service (initial malfunctions, wear, technical incidents, defective components, etc.). The large-scale implementation also allows tests by the users, which can be exploited for remote diagnosis. It even makes remote testing possible in the case of interactive systems, these remote tests being carried out directly by technicians installed in specialized premises, on decoders in place at the users' premises.

To this end, the subject of the invention is a system for testing the compliance of a digital device for decoding encoded video signals. This system comprises:
a unit for comparing, over time, results obtained from video test sequences by means of the digital decoding device to be tested and reference results relating to said video test sequences,
and a unit for computing at least one quality parameter relating to these results and nonlinear as a function of these results.

According to the invention:
the computing unit is provided in order to separately calculate the quality parameters from the results obtained by means of the digital decoding device to be tested,
and the comparison unit is provided in order to compare the quality parameters associated with the digital decoding device to be tested and the quality parameters associated with the reference results.

More specifically, the comparison unit is designed to produce binary results corresponding respectively to the quality parameters, by means of predetermined tolerance margins corresponding respectively to the quality parameters, by allocating to each of the binary results corresponding to one of these quality parameters:
a first value when the quality parameter associated with the decoding device to be tested remains within the tolerance margin around the quality parameter associated with the reference results, over time,
and otherwise, a second value.

Thus, the invention is based on calling into question methods systematically applied in the field of compliance tests. Specifically, instead of finding the pixel by pixel difference between images obtained by means of the decoding device to be tested (hereinafter “test images”) and reference images, then calculating significant parameters, as in the prior art U.S. Pat. No. 6,137,904, the quality parameters are initially calculated and only the difference between the parameters calculated from the results obtained by means of the decoding device to be tested (hereinafter “test parameters”) and results is the reference are found. Furthermore, by employing binary results corresponding respectively to the quality parameters, the binary judgement of compliance or noncompliance is dissociated, by scaling it down between all the parameters.

This approach, which could possibly seem logical for linear parameters depending on results, is contrary to all expectation for nonlinear parameters. This is because very different values are generally obtained depending on whether or not the pixel-by-pixel difference is initially found between the test and reference images, before calculating the parameters. Now, it is commonly admitted that only pixel-by-pixel differences with reference images can produce reliable information concerning the compliance of a decoder. It is certainly known how to calculate quality parameters independently for a decoder, since they are considered as beneficial sources of information. However, as criteria certifying compliance, they are only envisaged after the step of finding a pixel-by-pixel difference with the reference images.

The system of the invention will therefore come up against ideas received in this field, by being satisfied with basing compliance tests on preselected parameters, directly compared with the results obtained by means of the decoding device to be tested (hereinafter “test results”) and the reference results. This involves a surprising simplification, insofar as some problems are thus necessarily and deliberately ignored, which problems cannot be detected by a set of given parameters.

However, by giving up an accurate characterization, the focus is thus on really significant aspects, which make it possible to identify predefined anomalies, in particular local degradation, and to detect off-limit behavior. Moreover, the latitude for choosing parameters and associated tolerances offers a broad range of possibilities, which can be selected according to the standards involved and the auxiliary analysis requirements (diagnostics). These possibilities can be adapted (change of standards, new decoder models, identification of specific problems, etc.) and are very flexible in use. Preferably, they are implemented by means of lengthy tests, capable of detecting abnormal behavior and thus of detecting a population of decoders which are outside the standards.

The advantage of the system of the invention, with respect to one which is based on a technique where the difference between test and reference images is found beforehand, pixel by pixel, before parameter calculation, is based on the independence of determining quality parameters for both types of images. Specifically, in a prior step, it is possible to obtain once and for all the changes in the quality parameters associated with the reference results, and to record them in a storage space (memory, disk, cassette, etc.). Later, it is then enough to calculate the quality parameters just for the test results, then to find the difference between them and the recorded parameters, overtime.

Thus, the entire step of finding the pixel-by-pixel difference is superseded. Given that the number of parameters (for example about ten) is preferably very much less than the number of pixels, the step of finding the difference between the parameters is relatively low cost in terms of computing, such that the really significant bulk of operations is based on calculating quality parameters for the test results. It can therefore be seen that the saving in computing generated with each compliance test is given approximately by all the operations required to calculate the pixel by pixel difference between the results exploited respectively for the test and reference images. Furthermore, it is not necessary to store the set of reference results for all the pixels, which would require considerable storage space in the presence of a large number of images (or re-calculating results with each test), but it is enough to retain the parameter changes. The saving in storage is therefore also very considerable.

With regard to existing techniques making it possible to produce quality ratings by differences between nonlinear parameters as a function of results, such as the method disclosed in document EP-A-0 986 269, the system of the invention adopts a completely different approach, based on introducing tolerance margins and binary results. For the reasons mentioned above, a person skilled in the art would have considered these known techniques as inappropriate to compliance tests, since they are not based on finding pixel-by-pixel differences between images produced by a decoder to be tested and reference images.

Among various additional possible advantages of the system of the invention, mention may be made of:
the development of a global tool for validating mass-produced products by means of a black box;
carrying out tests in the factory;
the ability to compare two mass-produced products directly;
the selection of a quality level to be attained;
independence with regard to the quality of 4:2:0 video samples before MPEG video encoding, by using a reference decoder;
independence with regard to analog-digital conversions on the same product line;
the changing appearance of test rigs;
the ability to test for other parameters of the MPEG/DVB syntax than for video compliance; by selecting video test sequences so that decoding errors (for example at transport syntax level) involve video impairments, the test possibilities are in fact extended to any syntax level; and
taking account of errors appearing at any level of the broadcast channel.

The binary values obtained are themselves preferably condensed into an overall binary value. According to a first synthesis method, the first and second values are respectively equal to 1 and 0 for each of the quality parameters. All the values respectively obtained for the various parameters are then multiplied in order to determine the overall value: the value of the latter is therefore 1 only when compliance is guaranteed for all the parameters, and 0 otherwise. In this method, failure of any one of the parameters leads to failure of the entire decoder.

According to a second synthesis method, the first and the second values are also respectively equal to 1 and 0 for each of the quality parameters. However, all the values obtained respectively for the various parameters are added, so as to obtain a cumulated value. The ratio of the latter to the maximum possible value for this cumulated value, that is to say to the total number of parameters taken into account, is then taken. This ratio of the cumulated value, expressed as a percentage, is compared to a tolerance threshold (for example 85%): the decoder is then only considered as compliant when the cumulated value is greater than the threshold. In this method, failure with respect to one of the parameters is not insurmountable, but must be compensated for by good performance with regard to other parameters. In a more sophisticated version of this second method, the cumulated value is a weighted sum of elementary values obtained for the various parameters.

In a third synthesis method, the two first methods are combined, so as to guarantee, for example, the systematic compliance of the decoder with regard to certain parameters or certain combinations of parameters.

The reference parameters may be obtained in various ways. Thus, in a first embodiment, the computing unit is provided in order to calculate them from video test sequences decoded by means of a reference decoder. In a second embodiment, these reference parameters are directly extracted from video test sequences, without passing through encoding then decoding steps. In a third embodiment, the reference parameters are determined by computer simulation, without using real measurements. The model used then artificially generates the encoded video signals, coming from imaginary video test sequences.

The system of the invention, designed for application to two-dimensional images, is even more obviously advantageous in the presence of digital transmissions of three-dimensional images (for example, for holographic television).

The computing parameters are advantageously adapted to models of perception by the human eye.

Preferably, since the results are defined in a spatial space, the computing unit is provided in order to calculate at least one quality parameter which is a function of at least one spectral distribution of at least one measurement variable extracted from these results. This spectral distribution consists of a weighted intensity integration of this measurement variable in at least one integration region drawn in a spectral space, this spectral space resulting from a frequency transformation of at least part of spatial space. Spectral space is associated with radial and angular values.

The measurement variables are advantageously chosen from luminance and chrominance values or a combination of these two types of values.

Such spectral distributions prove to be particularly suitable for compliance tests. The distributions may directly constitute certain quality parameters, or be combined together or subjected to various linear or nonlinear operations in order to give these parameters. The spectral distributions are especially suitable for highlighting “tiling effects” in the images.

The spectral space is designed to be two-dimensional, in relation to the two-dimensional spatial space of the video images (the regions are then surfaces). However, in one embodiment adapted to three-dimensional transmissions, the spectral space is three-dimensional (the regions are then volumes).

Preferably, the integration is weighted by radial values.

Moreover, advantageously, at least one of the quality parameters is a function of the ratio of the spectral distribution associated with the integration region to the spectral distribution associated with an additional region of this integration region in spectral space.

Thus, the moments of inertia of the spectra are measured.

Advantageously, at least one of the integration regions is located in an angular sector of spectral space and/or between two radial values. This technique simplifies the computing methods. The term “angular sector” refers, in two dimensions, to part of the plane limited by two half-lines of the same apex at the origin, and, in three dimensions, to the internal volume of a cone of revolution having the origin as the apex.

Specific regions of spectral space make it possible to obtain particularly useful information.

Thus, according to a first preferred way of selecting regions, at least one of these regions is located at at least one frequency axis of spectral space. It is noticed that such regions are suitable for indicating the appearance of macro blocks following decoding errors.

According to a second preferred way of selecting regions, at least one of these regions is located at a radial value within an interval of high radial values, this interval corresponding to an upper third of radial intensity distribution of the measurement variable. It is noticed that such regions are suitable for identifying jumps of the YUV components. This is because the latter result from a spectrum with a wealth of high frequencies, therefore with a high moment of inertia.

Advantageously, the system also comprises a synchronization unit intended to add, for each of the test video sequences upstream from the decoding device to be tested, an encoded synchronization sequence comprising a good quality part and a part with degradation, adjacent to the good quality part. The reference results comprise corresponding synchronization sequences. Thus is it possible to ensure perfect synchronization between the variations of the test parameters and those of the reference.

The invention is also applicable to a method for testing the compliance of a digital device for decoding video signals. According to this method:
results obtained from video test sequences by means of the digital decoding device to be tested are compared over time with reference results relating to the video test sequences,
and at least one quality parameter relating to the results and nonlinear as a function of said results is calculated.

According to the invention:
the quality parameters associated with the reference results are determined separately beforehand and said parameters are recorded,
the quality parameters are computed separately on the basis of the results obtained by means of the digital decoding device to be tested,
and the quality parameters associated with the digital decoding device to be tested are compared with the quality parameters associated with the reference results.

For the comparison step, binary results are produced corresponding respectively to the quality parameters, by means of predetermined tolerance margins corresponding respectively to the quality parameters, thereby allocating to each of the binary results corresponding to one of the quality parameters:
a first value when the quality parameter associated with the decoding device to be tested remains within the tolerance margin around the quality parameter associated with the reference results, over time,
and otherwise, a second value.

The method is preferably implemented by means of any one of the embodiments of the system of the invention.

The invention also relates to a digital decoding unit comprising a digital decoding device. According to the invention, this decoding unit includes a system for testing the compliance of the decoding device according to any one of the embodiments of the system of the invention. This decoding unit preferably consists of a receiver provided with a decoder (IRD).

According to a particular embodiment, the test system of the invention can be downloaded to the receivers, via a test application distributed over a given channel, for example over a specific channel of a satellite. It is then possible to carry out a remote self-diagnosis of the state of a decoder, from a diagnosis center.

The invention will be better understood and illustrated by means of the following exemplary embodiments and implementational examples, which are in no way limiting, with reference to the appended figures in which:

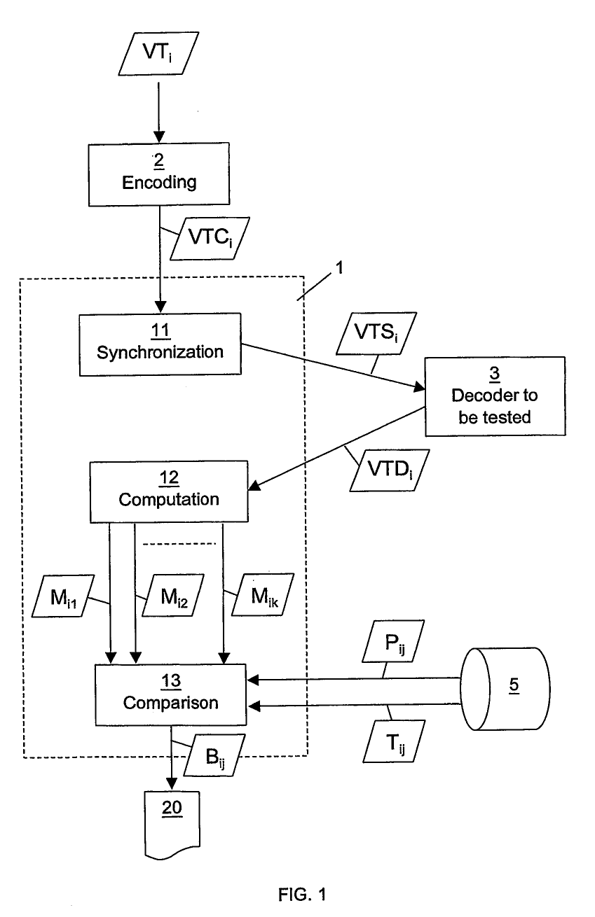

FIG. 1 is an outline diagram of a test system according to the invention, implemented during operations of testing a decoding device to be tested;

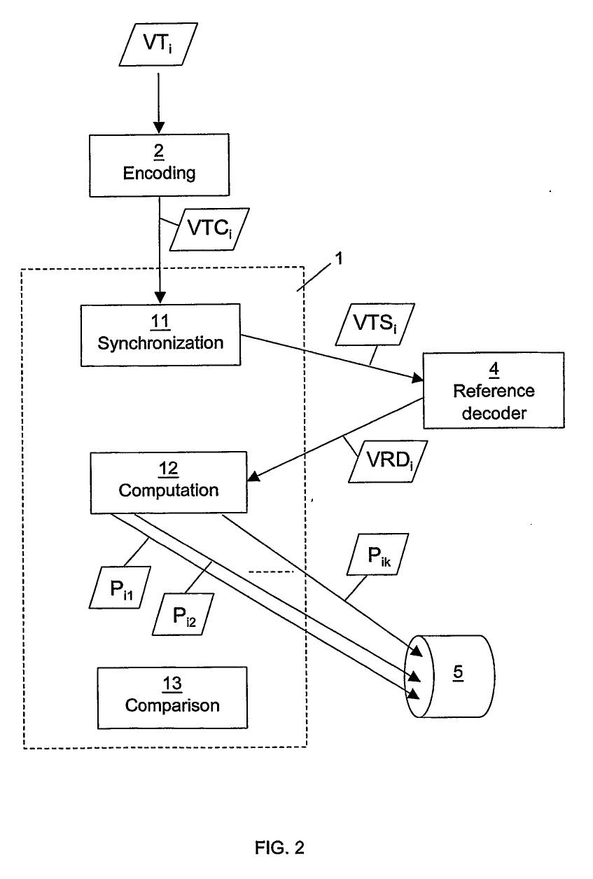

FIG. 2 shows the test system of FIG. 1 during preliminary operations of determining and storing parameters obtained by means of a reference decoding device;

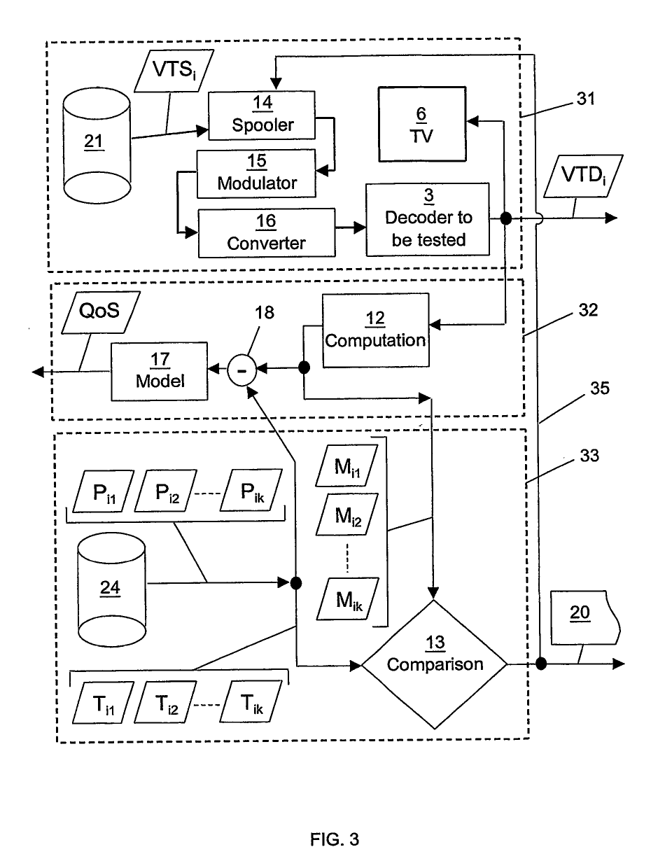

FIG. 3 illustrates schematically a set of elements involved in implementing the test system of FIGS. 1 and 2;

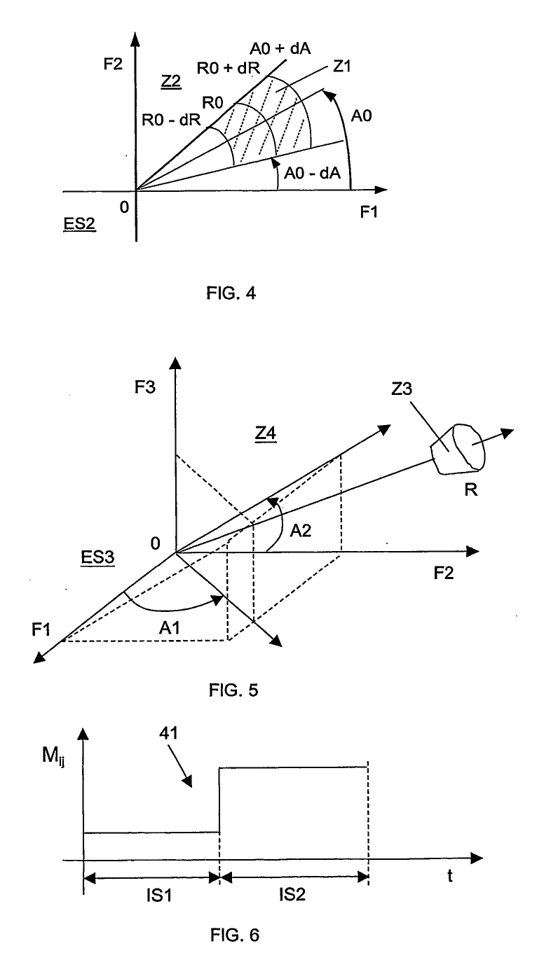

FIG. 4 represents a region for computing a spectral distribution in a two-dimensional spectral space, used by a computing unit of the test system of FIGS. 1 and 2 in order to calculate some of the quality parameters;

FIG. 5 represents a region for calculate a spectral distribution in a three-dimensional spectral space, used by a computing unit of the test system of FIGS. 1 and 2 in order to calculate some quality parameters, in an alternative embodiment;

FIG. 6 illustrates an initial synchronization sequence, represented for one of the test parameters obtained by means of the test system of FIGS. 1 and 2;

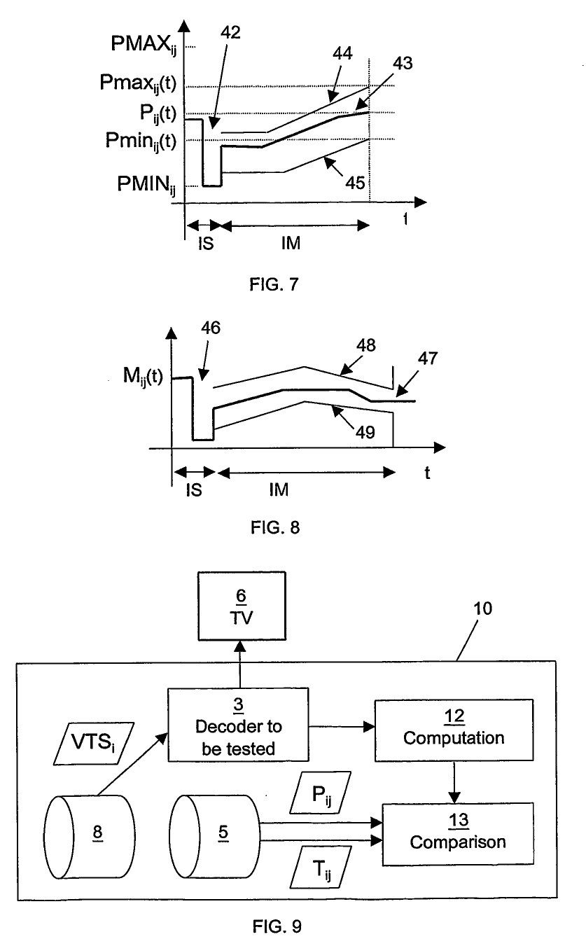

FIG. 7 represents the temporal variation of one of the reference parameters obtained by means of the test system of FIGS. 1 and 2, together with a corridor of validity formed around this temporal variation from tolerance margins for this parameter;

FIG. 8 represents the temporal variation of a test parameter obtained by means of the test system of FIGS. 1 and 2, together with a corresponding corridor of validity, determined in a similar manner to that of FIG. 7; and

FIG. 9 shows diagrammatically a receiver with a decoder, including the decoding device to be tested and a test system according to the invention, including the computing and comparison units of the test system of FIGS. 1 and 2.

A test system 1 (FIGS. 1 and 2) is used to verify the compliance of a decoder 3. It comprises a computing unit 12, designed to calculate the change over time of quality parameters from decoded video sequences, and a comparison unit 13, designed to compare the calculated quality parameters with parameters stored in memory. The test system 1 further comprises a synchronization unit 11, capable of adding a synchronization sequence to the start of the encoded video sequence. This synchronization sequence makes it possible for the change over time of the quality parameters respectively computed and stored in memory to be made to coincide accurately.

During operation, a set of basic video test sequences VT₁, VT₂, . . . VTₙ, chosen for their ability to make the operating qualities of the decoders emerge in a discriminating manner, are used. An encoding unit 2 makes it possible to produce encoded video test sequences VTC₁, VTC₂, . . . VTCₙ, respectively, from basic video test sequences VT₁, VT₂, . . . VTₙ. Next, initial synchronization sequences are inserted at the start of these sequences, by means of the synchronization unit 11. Thus, encoded and synchronized video test sequences VTS₁, VTS₂, . . . VTSₙ are obtained. The latter sequences are successively subjected to the decoder 3 to be tested, which transforms them into decoded video test sequences VTD₁, VTD₂, . . . VTDₙ, respectively. The latter are reconstructions, after encoding and decoding, of the basic video test sequences VTᵢ, with additions of initial synchronization portions.

The decoded sequences VTDᵢ are successively inserted into the computing unit 12, which produces, for each of these sequences VTDᵢ and at each time t, a whole set of parameters Mᵢ₁, Mᵢ₂, . . . Mᵢₖ. The time-varying curves Mᵢⱼ(t) of these parameters Mᵢⱼ are then compared respectively to the reference time-varying curves Pᵢⱼ(t), available in a storage space 5. The comparison is considered as satisfactory for compliance of the decoder 3 only when the calculated time-varying curves Mᵢⱼ(t) are within acceptable limits in relation to the reference time-varying curves Pᵢⱼ(t), with regard to the respective tolerance margins Tᵢⱼ also kept in the storage space 5. Thus, compliance test results 20 are obtained, which contain binary information (decoder 3 compliance/noncompliance), and possibly more detailed information concerning the performance of the decoder 3 with respect to several criteria represented by the parameters Mᵢⱼ.

More specifically, a binary flag Bᵢⱼ is allocated to each of the quality parameters Mᵢⱼ, to which flag the value 1 is given if this parameter is acceptable and otherwise, a value 0. The binary compliance information may then be expressed by an overall flag B computed by:

$$B = {{\prod }_{i = 1 … n}^{}}_{j = 1 … k} {B}_{ij} ,$$

the value of this flag being 1 if the decoder complies (all the parameters are acceptable) and otherwise 0.

In another determination method, this overall flag depends on a satisfaction percentage p, and has the value:

$$B = 1 if ( {{\sum }_{i = 1 … n}^{}}_{j = 1 … k} {B}_{ij} ) \times 100 / ( n \times k ) > p , otherwise 0.$$

The reference quality parameters Pᵢⱼ can be generated in various ways. A simple and reliable means consists in using the same means as for testing the decoder 3 (FIG. 2), but by using, instead of the latter, a reference decoder 4, the decoding qualities of which have been proven. Thus, by means of this decoder 43 decoded reference sequences VRD₁, which allow the extraction of the reference parameters Pᵢⱼ, are respectively produced from basic video test sequence Vᵢ.

In another method of calculating these parameters Pᵢⱼ, the computing unit 12 is directly used on the basic video test sequences VTⱼ, completed by suitable initial synchronization sequences. According to yet another technique, ideal variations of these parameters Pᵢⱼ are approached artificially by simulation.

Similarly, in alternative implementations, files containing the encoded and synchronized video sequences VTSᵢ are stored, which are used directly to test the decoder 3.

Moreover, the test system 1 advantageously comprises means which allow a user to modify the tolerance margins Tᵢⱼ for selecting the desired parameters Pᵢⱼ and/or to choose the method of determining the compliance of the tested decoder 3.

The methods of producing and implementing the test system 1 will now be detailed in particular examples for automatically validating MPEG/DVB compliance. A set of elements involved in a test procedure thus essentially comprises (FIG. 3) three modules: a first decoding module 31, a second quality estimation module 32 and a third automatic validation module 33.

The decoding module 31 includes the decoder 3 to be tested, incorporated in an IRD and connected to a television set 6, and comprises a disk 21 on which the video test sequences VTSᵢ, encoded to the MPEG-2 format and synchronized, are recorded. The disk 21 allows any desired modifications or additions in the base of the recorded video test sequences VTSᵢ. The latter are presented in the form of elementary video streams incorporated in transport streams according to the DVB standard, with suitable signaling of the PSI/SI (“Program Specific Information/Service Information”) type. Each of them comprises an initial synchronization sequence including a first high-quality part and a second part with samples of 4:2:0 type which are already impaired (in a typical manner) and encoded like an MPEG-2 elementary video stream. Because the MPEG-2 syntax of the second part is error free, the synchronization sequences do not introduce perturbations in the IRD before the start of the significant part of the test sequences VTSᵢ. The synchronization unit 11 is therefore not used in this case, or is used upstream in order to determine these sequences VTSᵢ (thus, it is not shown in FIG. 3).

Moreover, the test sequences VTS, are selected in particular for their ability to take account of local impairments, by the suitable choice of quality parameters Mᵢⱼ measured over time. Advantageously, provision is made to test the syntax of several quantities, such as, for example:
the syntactic analysis (“parsing”) of transport packets (transport error, start-up flag for the payload unit, transport priority, scrambling, adaptation field, discontinuity, random access flag, etc.);
parsing of packetized elementary streams or PES (syntactic analysis of audio/video, audio/video synchronization, teletext and subtitling PES, other VBI—for “Vertical Blanking Information”—data);
parsing of sections (syntax, length, rating, etc.);
the syntax of digital video streams:
   video sequence (for header sequence: resolution, image rating, digital rating, etc.; extension and user data; for sequence extension: profile and level, progressive sequence, chrominance and short delay format; for extension of sequence display: video format, display color and size description; for groups of images: temporal code, broken link and header structure);
   image header (temporal reference, type of image coding, other syntax elements, extension of image coding, extension of quantization matrix, extension of image display, extension of temporal/scalable spatial image, extension of copyright, image data);
   slice;
   macro block;
   block.

This module 31 also comprises, in sequence, a driver 14 or spooler for an MPEG flow, a radio frequency modulator 15 and a frequency up-converter 16. The transport streams emitted by this channel are received by the decoder 3 to be tested, which produces decoded (and synchronized) video test sequences VTDᵢ.

The quality estimation module 32 comprises the computing unit 12 and a subtraction unit 18, provided to find the difference over time between the quality parameters Mᵢⱼ calculated by the computing unit 12 and the reference quality parameters Pᵢⱼ. The quality estimation module 32 also comprises a unit 17 for allocating QoS (quality of service) quality notes, based on the exploitation of a predefined perceptual model applied to the information concerning separation from the subtraction unit 18. These quality notes QoS are made available to users.

According to a particularly beneficial method of calculating quality parameters Mᵢⱼ by the computing unit 12 (FIG. 4), a two-dimensional (frequency axes F1 and F2) spectral space ES2, resulting from a frequency transformation of a two-dimensional spatial space with reference to a vertical axis and a horizontal axis, is considered. Each point in spectral space ES2 is located by a radius R and an angle A. The intensity values of one or more measurement variables each extracted from images belonging to the successive decoded sequences VTDᵢ—for example the average luminance and chrominance—are defined in this spectral space ES2.

Furthermore, a specific region Z1 of spectral space ES2, having an additional region Z2 in this space, is of interest. In the advantageous example described, the region Z1 is a portion of a ring centered around a point of coordinates (R0, A0), of angular separation equal to 2×dA and of radial width equal to 2×dR. By denoting the values of the measurement variable in question by “coef” (for the i-th sequence and the j-th parameter), the quality parameters Mᵢⱼ are computed overtime by the formula:
Mᵢⱼ=[∫∫_{Z1}(R×coef)]/[∫∫_{Z2}(R×coef)]

Advantageously, at least one of the regions Z1 used is centered at one of the frequency axes F1 or F2 and/or high values of the radius R, that is to say within an interval corresponding to an upper third of intensity distribution of the measurement variable.

In alternative embodiments, at least some of the test parameters Mᵢⱼ are derived from calculated parameters, as indicated above, and/or are combinations of such parameters.

In an evolved embodiment (FIG. 5), the computing module 12 is also capable of processing images in three dimensions. Thus it proceeds in a manner similar to the two-dimensional treatment, but being placed in a three-dimensional spectral space ES3 (frequency axes F1, F2 and F3), obtained by frequency transformation from spatial space for defining images. In this space, ES3, each point is defined by two angles A1 and A2 and a radius R. Use is then made of integration regions Z3 formed from volumes and of complementary regions Z4 in spectral space ES3, to establish formulae of the same type as those in two dimensions:
Mᵢⱼ=[∫∫∫_{Z3}(R×coef)]/[∫∫∫_{Z4}(R×coef)]

Preferably, each of the integration regions Z3 is a portion of spherical shell of the type centered about a point having coordinates (R0; A1, A2), with angular separations equal to 2×dA and of radial width equal to 2×dR.

Each of the test parameters Mᵢⱼ has a time-varying curve Mᵢⱼ(t) having an initial synchronization portion 41 (FIG. 6). This portion 41 consists of a first part over a time interval IS1, corresponding to a good-quality video sequence, and a second part over a time interval IS2, corresponding to a sequence with degradation (for example, heterogeneities between blocks).

The automatic validation module 33 comprises a disk 24 on which the reference time-varying curves Pᵢⱼ(t) and the tolerance margins Tᵢⱼ are recorded, together with the comparison unit 13, producing the results 20 of compliance tests. The reference parameters Pᵢⱼ are used by the subtraction unit 18 and the comparison unit 13 in combination with the calculated test parameters Mᵢⱼ.

The comparison unit 13 uses the information extracted from the disk 24 in order to define, around each of the reference time-varying Pᵢⱼ(t) curves 43 (FIG. 7), a range of validity. Thus, beyond a synchronization interval IS, an upper curve 44 (time-varying curve Pmaxᵢⱼ(t)) and a lower curve 45 (time-varying curve Pminᵢⱼ(t)) are deduced from the curve 43 over a temporal measurement interval IM.

To determine the upper 45 and lower 44 curves, a quality percentage QPᵢⱼ, which expresses the tolerance margin Tᵢⱼ, is used according to an advantageous embodiment. Since the parameter Pᵢⱼ varies over time t within a range between PMINᵢⱼ and PMAXᵢⱼ, we then have:
Pmaxᵢⱼ(t)=Pᵢⱼ(t)+(1−QPᵢⱼ/100)×½×(PMAXᵢⱼ−PMINᵢⱼ),
Pminᵢⱼ(t)=Pᵢⱼ(t)−(1−QPᵢⱼ/100)×½×(PMAXᵢⱼ−PMINᵢⱼ).

The comparison unit 13 has the function of verifying that, for each of the time-varying Mᵢⱼ(t) curves 47 obtained for one of the quality parameters Mᵢⱼ (FIG. 8), beyond the synchronization portion 46, the curve 47 remains between the lower 48 (Pminᵢⱼ(t)) and upper 49 (Pmaxᵢⱼ(t)) curves associated with this quality parameter Mᵢⱼ. Depending on whether this limitation is verified or not, the comparison unit 13 allocates a success or failure value to the corresponding result (for example, by allocating the value 1 or 0 to the binary flag Bᵢⱼ).

When the parameters Mᵢⱼ are chosen so as to have a value which increases with the video quality, it is necessary to use only the lower curves Pminᵢⱼ(t).

The results 20 relating to each of the test sequences VTSᵢ are computed and returned to an external system. Furthermore, a feedback line 35 connected to the spooler 14 allows automatic triggering for sending the test sequence VTSᵢ₊₁ following the one which has just been processed. Thus, a series of test steps on the various video test sequences is authorized without any human intervention. Furthermore, in the embodiments for which validation must be successful for each of the video test sequences VTSᵢ, the operations are interrupted as soon as one of the results 20 is unsatisfactory for one of the test sequences VTSᵢ. The feedback line 35 is then deactivated, which makes it possible to save on useless processing.

In an alternative embodiment, each of the parameters Mᵢⱼ is validated by visually controlling the inclusion of time-varying Mᵢⱼ(t) curves 47 in the corridors delimited by the lower 48 (Pminᵢⱼ(t)) and upper 49 (Pmaxᵢⱼ(t)) curves respectively associated with the parameter Mᵢⱼ.

1. A system for testing the compliance of a digital device for decoding encoded video signals, comprising:
a unit for comparing, over time, results obtained from video test sequences by means of the digital decoding device to be tested and reference results relating to said video test sequences,
and a unit for computing at least one quality parameter relating to said results and nonlinear as a function of said results,
wherein
the computing unit is provided in order to separately calculate said quality parameters from the results obtained by means of the digital decoding device to be tested,
and the comparison unit is provided in order to compare said quality parameters associated with the digital decoding device to be tested and said quality parameters associated with the reference results, and in order to produce binary results corresponding respectively to the quality parameters, by means of predetermined tolerance margins corresponding respectively to the quality parameters, by allocating to each of said binary results corresponding to one of said quality parameters:
a first value when said quality parameter associated with the decoding device to be tested remains within the tolerance margin around said quality parameter associated with the reference results, over time,
and otherwise, a second value.

2. The system as claimed in claim 1, wherein, since said results are defined in a spatial space, the computing unit is provided in order to calculate at least one quality parameter which is a function of at least one spectral distribution of at least one measurement variable extracted from said results, said spectral distribution consisting of a weighted intensity integration of said measurement variable in at least one integration region drawn in a spectral space, said spectral space resulting from a frequency transformation of at least part of said spatial space and being associated with radial and angular values.

3. The system as claimed in claim 2, wherein said integration is weighted by said radial values.

4. The system as claimed in claim 2, wherein at least one of the quality parameters is a function of the ratio of the spectral distribution associated with said integration region to the spectral distribution associated with an additional region of said integration region in spectral space.

5. The system as claimed in claim 2, wherein at least one of said integration regions is located in an angular sector of said spectral space and/or between two radial values.

6. The system as claimed in claim 2, wherein at least one of said regions is located at at least one frequency axis of said spectral space.

7. The system as claimed in claim 2, wherein at least one of said regions is located at a radial value within an interval of high radial values, said interval corresponding to an upper third of radial intensity distribution of said measurement variable.

8. The system as claimed in claim 1, wherein it also comprises a synchronization unit intended to add, for each of the test video sequences upstream from the decoding device to be tested, an encoded synchronization sequence comprising a good quality part and a part with degradation, adjacent to the good quality part, the reference results comprising corresponding synchronization sequences.

9. A method for testing the compliance of a digital device for decoding encoded video signals, in which:
results obtained from video test sequences by means of the digital decoding device to be tested are compared over time with reference results relating to said video test sequences,
and at least one quality parameter relating to said results, and nonlinear as a function of said results is calculated,
characterized in that wherein:
said quality parameters associated with the reference results are determined separately beforehand and said parameters are recorded,
said quality parameters are computed separately on the basis of the results obtained by means of the digital decoding device to be tested,
and said quality parameters associated with the digital decoding device to be tested are compared with said quality parameters associated with the reference results, thereby producing binary results corresponding respectively to the quality parameters, by means of predetermined tolerance margins corresponding respectively to the quality parameters, and thereby allocating to each of said binary results corresponding to one of said quality parameters:
a first value when said quality parameter associated with the decoding device to be tested remains within the tolerance margin around said quality parameter associated with the reference results, over time,
and otherwise, a second value,
said method preferably being implemented by means of a system according to claim 1.

10. A digital decoding unit comprising a digital decoding device, wherein it includes a system for testing the compliance of said decoding device according to claim 1, said decoding unit preferably consisting of a receiver provided with a decoder.
